(19) United States
(12) Patent Application Publication
(10) Pub. No.: US 2004/0066296 A1
(43) Pub. Date: Apr. 8, 2004

(54) Tamper indicating radio frequency identification label with tracking capability

(76) Inventor: Peter S. Atherton, Leesburg, VA (US)

Correspondence Address: VENABLE, BAETJER, HOWARD AND CIVILETTI, LLP, P.O. BOX 34385, WASHINGTON, DC, 20043-9998, US

(21) Appl. No.: 10/416,921

(22) PCT Filed: Nov. 15, 2001
(86) PCT No.: PCT/US01/51432

(51) Int. Cl. G08B 13/14

(52) U.S. Cl. 340/572.1; 340/572.8

(57) ABSTRACT

A tamper indicating label (100) is provided. The label may include RFID components (401, 402) and a tamper track (102) coupled to the RFID components. The tamper track should be constructed from a destructible conducting path. Additionally, the tamper track can be formed such that it is damaged when the label is tampered. In one embodiment, adhesion characteristics (103) of the tamper track are adapted to break apart the tamper track when the label is tampered, for example, by removal from an object. The RFID components may retain their RF capability and detect when the tamper track has been damaged to indicate that the label has been tampered. Alternatively, the RFID capability of the RFID components may be disabled when the tamper track is damaged, indicating tampering.

### BACKGROUND OF THE INVENTION

Radio Frequency Identification (RFID) is being used increasingly as a means to identify goods at a distance, without requiring physical contact or even line of sight access to the goods. RFID enables information about an item to be stored on an item, and in some implementations also allows this stored information to be modified at a distance. The most compact and cost effective means to provide this RFID capability is by means of a pressure sensitive (i.e. self adhesive) label incorporating an RFID capability.

The ability to detect remotely whether a pressure sensitive label or seal applied to an item has been tampered with or removed is becoming increasingly important in order to detect theft, product substitution, tampering, warranty violation and other problems.

A disadvantage of current pressure sensitive label technology is that it does not allow the remote determination of whether or not a label has been tampered with or removed and relocated.

### DISCLOSURE OF THE INVENTION

A tamper indicating label is provided. The label may comprise RFID components and a tamper track connected to the RFID components. The tamper track is preferably formed by destructible electronics. The tamper track may be modified, interrupted, or substantially disrupted when the label is tampered with. In one embodiment, the RFID components are able to detect the modification in the tamper track while maintaining their RFID capability. Detection of the modification in the tamper track indicates tampering with the label. In an alternative embodiment, the modification in the tamper track disables the RFID function.

In a further embodiment, the label comprises an RFID layer. The RFID layer may include a memory chip and at least one of an antenna and an induction loop. Means for attaching the RFID layer to an object may also be provided. The means for attaching may be an adhesive layer. The adhesive layer can support the RFID layer. A destructible conducting path may be sandwiched between the RFID layer and the adhesive layer. The destructible conducting path should be disrupted when the label is tampered. The disruption preferably modifies in some way the RFID characteristics of the RFID layer.

In a further embodiment, at least a part of the destructible conducting path may be in contact with the adhesive layer. The destructible conducting path can thereby be modified when the label is at least partially removed from a surface to which it is applied, and in turn, modify RFID characteristics of the label, indicating tampering.

According to another embodiment, the invention includes an RFID system. A substrate having a top and a bottom surface is provided. RFID electronic components are applied to the bottom surface of the substrate. A conductive layer may also be formed in a pattern on the bottom surface of the substrate. An adhesive layer may support the substrate such that the RFID electronic components and the conductive layer are sandwiched between the substrate and the adhesive layer. The adhesive layer, the substrate, and conductive layer should have relative adhesion strengths such that when the system is partially removed from a surface to which it has been applied, at least one of the RFID components and the conductive layer is altered to modify the RFID characteristics of the system.

According to another embodiment of the invention, a security apparatus for indicating tampering is provided. Here, an object may be provided with a conducting path having at least two end points. A security label is arranged on the object. The security label may be a tamper indicating label as described above and should include RFID components and a destructible conducting path between the RFID components and each individual end point.

In one of the more detailed embodiments of the invention, a security label is combined with an object. The security label may comprise RFID components and means for attaching the RFID components to the object. Destructible electronics may be connected to the RFID components. The destructible electronics can be broken when the label is at least partially removed from the object. The object comprises a surface for receiving the security label and a conducting path having two ends. The ends of the conducting path may be connected to the destructible electronics thereby forming a circuit through the RFID components, the destructible electronics and the conducting path. The RFID characteristics of the RFID components may be modified if the connection between the end points and the destructible electronics, or through the conducting path, is broken or disrupted.

According to another embodiment of the invention, a substrate having first and second portions is provided. The second portion of the substrate may be adapted to be looped back and connected to the first portion. An RFID transponder can be arranged on the substrate. A tamper track may be coupled to the RFID transponder and should extend at least partially into the second portion of the substrate. An adhesive layer should be provided on at least a part of the second portion of the substrate that includes the tamper track, the adhesive layer providing a means to attach the second portion to the first portion. The tamper track in that part of the substrate may be adapted to be modified, due to the relative adhesion strength of the tamper track, when the label is tampered.

In an exemplary embodiment, the tamper indicating label comprises an RFID layer providing an RFID function. An adhesive layer supports the RFID layer. A destructible electrically conducting path is arranged between the RFID layer and the adhesive layer, whereby the destructible conducting path is disrupted when the label is tampered, thereby modifying the RFID function of the RFID layer.

According to another embodiment, a tamper indicating label comprises. A substrate having first and second portions. The second portion is adapted to be looped back and connected to the first portion. RFID components are arranged on the substrate. A tamper track is arranged on the same side of the substrate as the RFID components. The tamper track is coupled to the RFID components and extends at least partially into the second portion of the substrate. The tamper track is preferably exposed in a part of the second portion of the substrate. An adhesive layer is arranged over the exposed part of the tamper track. The tamper track is adapted to be modified when the label is tampered due to the relative adhesion strength of the tamper track to the adhesive layer, thereby modifying the RFID function of the RFID components.

According to another embodiment, a tamper indicating label comprises a substrate having first and second surfaces. RFID components are arranged on the first surface of the substrate. At least one pair of through-connects extends through the substrate. First tamper tracks are formed on the first surface of the substrate and second tamper tracks are formed on the second surface of the substrate. The second tamper tracks are connected between the through-connects to the first tamper tracks, whereby the first and second tamper tracks are electrically connected to each other. An adhesive layer is arranged over the tamper tracks on the second surface of the substrate, whereby the second tamper tracks are interrupted or substantially disrupted when the label is at least partially removed from a surface to which it has been applied by means of the adhesive layer, thereby modifying RFID characteristics of the RFID components.

In a further embodiment, a method for reading information from an RFID label is provided. The RFID label incorporates an RFID apparatus that includes an integrated circuit chip. A property of the RFID apparatus is stored as first data values in a first memory of the integrated circuit chip. The first data values are read from the first memory with an RFID read/write apparatus. It is determined from the first data values if the RFID label has been tampered. Second data values are written to a second memory of the integrated circuit with the RFID read/write apparatus if the RFID label has been tampered.

### BRIEF DESCRIPTION OF THE FIGURES

The present invention will now be described by way of non-limiting example with reference to the accompanying drawings, wherein:

FIG. 1 is a schematic illustration of the general design of a tamper indicating RFID label which is the subject of the present invention;

FIGS. 2A and 2B are a schematic illustrations of a preferred embodiment and characteristics of the tamper indicating layer within a tamper indicating RFID label;

FIGS. 3A and 3B are schematic illustration of a preferred embodiment of the tamper indicating conducting strip in the tamper indicating layer of a tamper indicating RFID label;

FIGS. 4A and 4B are schematic illustrations of a preferred embodiment of a tamper indicating RFID label in which the tamper indicating conducting strip is in series with an induction loop in said label;

FIGS. 5A and 5B are schematic illustrations of a preferred embodiment of a tamper indicating RFID label in which the tamper indicating conducting strip forms the induction loop of said label;

FIGS. 6A and 6B are schematic illustrations of a preferred embodiment of a tamper indicating RFID label in which the tamper indicating conducting strips form the antenna of said label;

FIGS. 7A and 7B are schematic illustrations of a variation of RFID label of FIG. 6;

FIGS. 8A and 8B are schematic illustration of a method of manufacturing an RFID label according to an embodiment of the invention;

FIGS. 9A and 9B are schematic illustrations of another embodiment of the invention;

FIGS. 10A, 10B and 10C are schematic illustrations of the top view, side view and bottom view of a preferred embodiment of a tamper indicating RFID label which is the subject of the present invention;

FIG. 10D is a schematic illustration of the detail of a portion of the tamper indicating RFID label of FIG. 1;

FIGS. 11A-11C are schematic illustrations of a variation of the RFID label of FIG. 10;

FIGS. 12A-12I are schematic illustrations of loop tag based on the tamper indicating label design of FIGS. 9 and 10;

FIGS. 13A-13C are schematic illustrations of the use of a loop tag of the type illustrated in FIG. 12;

FIGS. 14A-14C are schematic illustrations of a variation of the tamper indicating RFID label design of FIG. 10;

FIGS. 15A-15C are schematic illustrations of another variation of the tamper indicating RFID label design of FIG. 10;

FIG. 16 is a schematic illustration of an object having a RFID label applied.

### DETAILED DESCRIPTION OF THE INVENTION

The term “passive”, as used herein, refers to an RFID label or transponder which does not include an on-board power source such as a battery. The term “active”, as used herein, refers to an RFID label or transponder which includes an onboard power source such as a battery. The advantages of an active RFID label, relative to a passive RFID label, is that an active RFID label can include continuous on-board functions such as a clock, and can usually enable longer read and write distances. A disadvantage of active RFID labels, relative to passive RFID labels, is that active RFID labels are physically larger due to the need to carry an on-board power source.

It should be appreciated that the terms label and tag may be used interchangeably in this document. Where the term label is used, the term tag may validly be substituted. The essential difference between the two is the thickness and types of material used in the construction. In general a label will be made from thin, flexible materials, while a tag will be made from thicker, stiffer materials. A tag may, for example, be similar to a plastic card with a pressure sensitive adhesive on the underside. Such tags may be used, for example, as compliance plates or rating plates or specification plates on various types of equipment. A tag, because of its greater thickness, is better suited to active RFID technology.

It should be appreciated that the illustrations herein are not to scale. In general the thickness of the label constructions (and component layers thereof) illustrated in the figures have been exaggerated, to illustrate more clearly the internal structures and components.

In general, a tamper indicating label is provided. The label may include RFID components and a tamper track coupled to the RFID components. The tamper track is an electrically conducting pathway or pathways, and should be constructed from a destructible conducting path. Additionally, the tamper track can be formed such that it is damaged when the label is tampered. In one embodiment, adhesion characteristics of the tamper track are adapted to break apart the tamper track when the label is tampered, for example, by removal from an object. The RFID components may retain their RFID capability and detect when the tamper track has been damaged to indicate that the label has been tampered. Alternatively, the RFID capability of the RFID components may be disabled when the tamper track is damaged, indicating tampering.

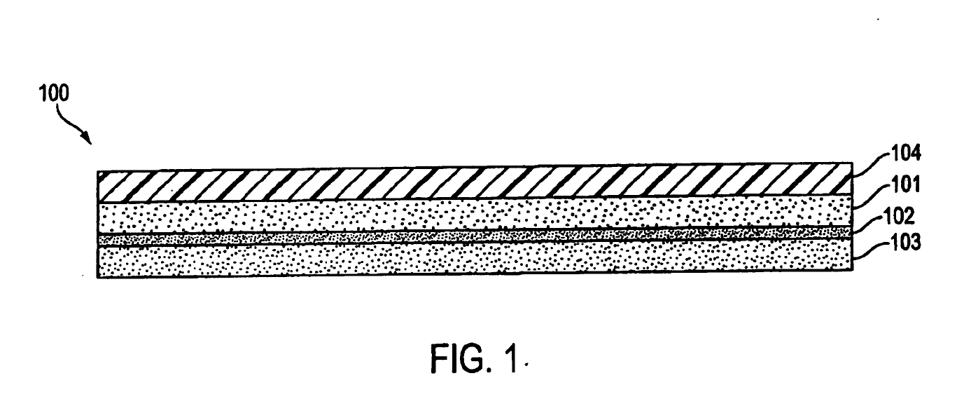

FIG. 1 is a schematic illustration of the general design of a tamper indicating RFID label according to an embodiment of the invention. FIG. 1 shows schematically a pressure sensitive (i.e. self-adhesive) label 100 in cross sectional view. The label 100 may include four functionally distinct layers.

The RFID layer 101 includes RFID components, such as (for example) an RFID memory chip. The label 100 may in some embodiments provide an “active” RFID capability, in which case the layer 101 can also include a battery or other power source.

The second layer 102 may include one or more thin electrically conducting tracks which should be coupled to the RFID components in the layer 101. The tracks are known herein as “tamper tracks” since they provide a means to detect tampering with or removal of the label 100 from a surface to which it has been applied.

The layer 101 and the layer 102 may together provide an RFID capability. On the other hand, in some embodiments the layer 101 can provide an RFID capability in its own right, while the tamper tracks 102 can modify the RFID performance of the layer 101 depending on whether the tamper tracks 102 are damaged or not.

The RFID capability provided by the layer 101, or the layers 101 and 102 together, usually includes the ability to store information in an RFID memory chip in the layer 101, and the ability to read and modify the stored information from a distance. Additional capabilities, such as the ability to encrypt stored information or control access to the stored information, may also be provided.

The third layer 103 may be an adhesive layer, which in some embodiments is a pressure sensitive adhesive.

The fourth layer 104 is a top-coat layer applied over the top of the RFID layer 101. The top-coat may be applied to protect the RFID layer and to provide a top surface to accept a printing process. The top coat layer 104 is not essential and in some embodiments may not be included. The finished construction is the adhesive label 100.

The tamper tracks 102 should be destructible. When the label 100 is applied to a surface and subsequently tampered or removed, the pressure sensitive adhesive 103 damages the tamper tracks 102—for example, by tearing all or part of them from the underside of the layer 101—which in turn affects the RFID performance of the label 100. Since the tamper tracks 102 are electrically connected to the RFID components in the label 100, and may form part of the RFID components of the label 100, the RFID function of the label 100 is modified if the label is applied to a surface and subsequently tampered or removed. In this way tampering with or removal of the label 100 can be detected at a distance via the change in the RFID characteristics and response of the label 100.

The terms “tampering” and “tampered” as used herein refer to complete or partial removal of a tamper indicating label, such as the label 100, from a surface to which it has been applied.

In this document the term “destructible” is used in relation to the tamper tracks 102 in FIG. 1 and in relation to other tamper tracks throughout the document. In this context the term destructible means that the tamper tracks are designed to be damaged or broken in regions of the label which are tampered.

The tamper tracks 102 may be produced in one of a number of different ways. In one preferred embodiment, the tamper tracks may be produced by printing electrically conducting ink (such as a carbon/graphite-based conductive ink or a precious metal ink). In another preferred embodiment the tamper tracks 102 may be produced using electrically conductive adhesive. In another embodiment, the tamper tracks may be metallic tracks made of Aluminum, Copper or some other suitable metal.

In general the tamper tracks 102 should be made from a material, such as an electrically conducting ink, which has appropriate electrical properties but which does not have high intrinsic physical strength. In this way the tamper tracks 102 can be more easily disrupted or damaged as the label 100 is partially or completely removed from a surface to which it has been applied.

In some preferred embodiments the destructibility of the tamper tracks 102 may be enhanced by including a thin layer of a suitable adhesion modifying coating on the underside of the layer 101 either between the layer 101 and the tamper tracks 102, or between the tamper tracks 102 and the adhesive layer 103. At least a part of the tamper tracks should preferably contact the adhesive 103. The layer of adhesion modifying coating may be applied as a uniform layer, or in a specified pattern, or in some other manner such that the properties of the adhesion modifying coating vary across the layer 101. In some embodiments multiple layers of adhesion modifying coating may be applied to “fine tune” the properties of the final composite adhesion modifying coating.

Inclusion of an adhesion modifying coating between the RFID layer 101 and the tamper tracks 102 results in the adhesion of these layers to each other being stronger or weaker in a particular region according to whether the adhesion modifying coating is present or absent in that region. Similarly, inclusion of an adhesion modifying coating between the tamper tracks 102 and the adhesive layer 103 results in the adhesion of the layers to each other being stronger or weaker in a particular region according to whether the adhesion modifying coating is absent or present in that region. Usually, but not necessarily, the adhesion modifying coating reduces the adhesion of two layers which it separates, so that the two layers can be more easily separated.

The relative adhesion between the layer 101, adhesion modifying coating, tamper tracks 102 and adhesive layer 103 can be adjusted so that when the label 100 is applied to a surface and subsequently tampered or removed, the tamper tracks 102 are damaged in a pattern corresponding to the pattern of the adhesion modifying coating. In some embodiments the tamper tracks 102 may be physically separated in a pattern corresponding to the pattern of the adhesion modifying coating, with some of the tamper tracks 102 remaining on the layer 101 and the remainder of the tamper tracks 102 remaining on the adhesive layer 103. This damage to the tamper tracks 102 may affect the RFID performance of the label 100.

The adhesion modifying coating may be a layer of lacquer, or a layer of tamper indicating varnish (for example, similar to that used in some visual tamper indicating label constructions), or a layer of some other suitable material formulation.

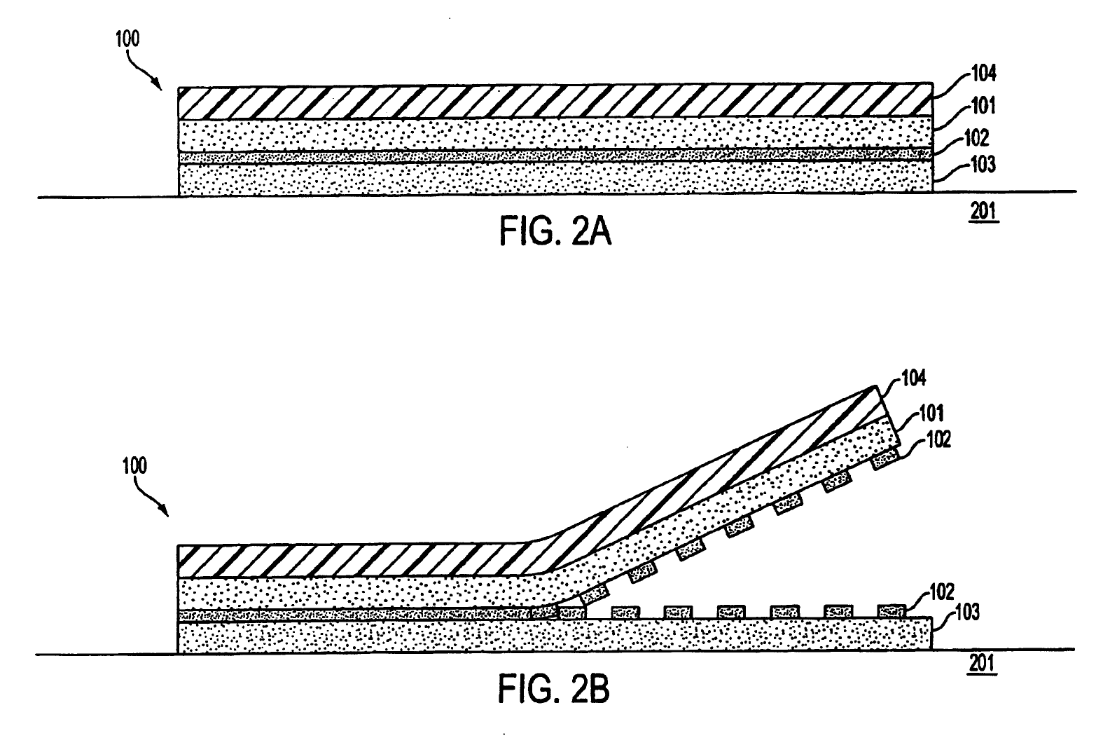

The tamper indicating characteristics of one preferred embodiment of the label 100 are illustrated in FIGS. 2A and 2B, which show the label 100 in cross section view before and after removal from a surface 201. FIG. 2B illustrates in particular the physical disruption of the tamper tracks 102 during tampering or removal of the label 100. In FIG. 2A the label 100 is shown before removal from the surface 201. Here the tamper tracks 102 are intact and the label 100 exhibits its normal RFID operation. In FIG. 2B the label 100 has been partially removed from the surface 201. As the label 100 is removed, portions of the tamper tracks 102 remain with the top layer 101, and complementary portions of the tamper tracks 102 remain with the adhesive layer 103. The differential separation of the tamper tracks 102 may in some embodiments be enhanced or achieved through the inclusion of an adhesion modifying coating (as described above) in a specified pattern at the interface between the layer 101 and the tamper tracks 102, such that the tamper tracks 102 bond less strongly to the layer 101 where the adhesion modifying coating has been applied and therefore in such regions the tamper tracks 102 remain with the adhesive layer 103 when the label 100 is removed from the surface 201. As the label 100 is removed from the surface 201, the tamper tracks 102 are damaged, and their electrical properties are thereby affected. This in turn affects the RFID properties of the label 100, since the tamper tracks 102 are electrically connected to the layer 101 which includes RFID components. In FIG. 2 the separation of (i.e. damage to) the tamper tracks 102 during tampering of the label 100 is shown to form a regular repeating pattern. It should be appreciated that the pattern of the separation may instead be irregular and may be on a larger or smaller scale relative to the size of the label 100 or the RFID components in the label 100 than shown in FIG. 2.

The label 100 may also contain information in another format, such as a barcode, 2D barcode, or some other optical information storage format printed on the top surface of the top coat layer 104.

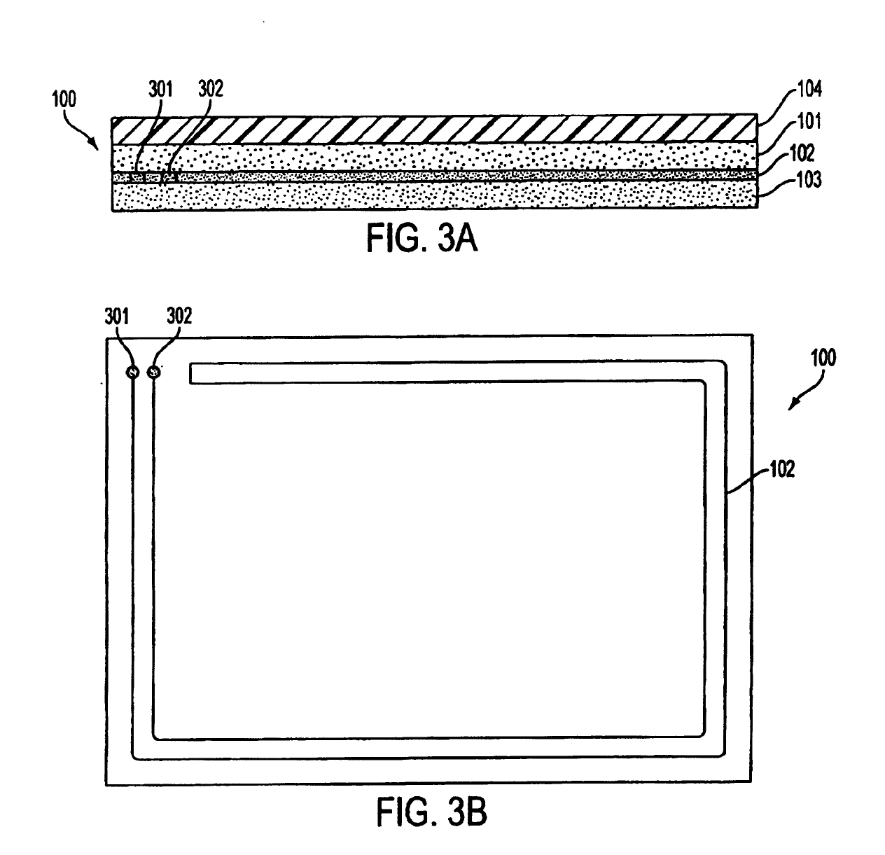

A preferred embodiment of the tamper tracks 102 will now be described with reference to FIGS. 3A-3B, which shows an embodiment of the RFID label 100 in cross sectional view and looking from below through the adhesive layer 103 at the tamper tracks 102. In FIG. 3 the RFID layer 101 has two “through-connect” electrical connection points, 301 and 302, where the electrical circuitry in the RFID layer 101 is connected to the underside of the layer 101. In this embodiment the electrical connection between the points 301 and 302 by means of the tamper track 102 should be intact in order to maintain normal RFID operation of the label 100.

Preferably the tamper track 102 may be disrupted even if only a portion of the label 100 is tampered. In FIG. 3B, the tamper track 102 runs around the perimeter of the underside of the layer 101 between points 301 and 302. This configuration for the tamper track 102 of FIG. 3 ensures that tampering of even a small portion of the perimeter of the label 100 will result in a break in or damage to the tamper track 102 and therefore a break in or disruption to the electrical connection between the points 301 and 302, which in turn modifies the RFID behavior of the label 100.

It should be appreciated that other configurations of the tamper track 102 could also be employed. For example, in some embodiments the tamper track 102 may form all or part of an antenna, in which case the points 301 and 302 may not be electrically connected to each other via a single tamper track 102.

An RFID label will generally include an electronic chip, such as an electronic memory chip, connected to either an induction loop or an antenna. The induction loop or antenna may enable communication and data exchange with a remote reading device. (It should be appreciated that different types of antenna design may be employed.) Other electrical or electronic components may also be included in an RFID label. An active RFID label will include an on-board power source such as a battery.

Preferred embodiments in which the tamper tracks 102 can be configured on the underside of the RFID layer 101 and coupled to the RFID layer 101 will be now be described by way of non-limiting example. It should be appreciated that in some embodiments the tamper tracks 102 may be designed to be destructible in some regions and durable in other regions. For example, the tamper tracks 102 may include some sections which are durable and rugged, joined by sections which are destructible.

The tamper tracks 102 may be connected in one of several different ways to the RFID layer 101, depending on the design and operation of the RFID layer 101. Several non-limiting examples are listed below.

1. The tamper tracks 102 may be connected in series with an induction loop or antenna in the layer 101.

2. The tamper tracks 102 may constitute all or part of the induction loop or antenna of the label 100.

3. The tamper tracks 102 may be part of a tamper-sensing electrical circuit in the label 100 which is separate from the induction loop or antenna of the label 100.

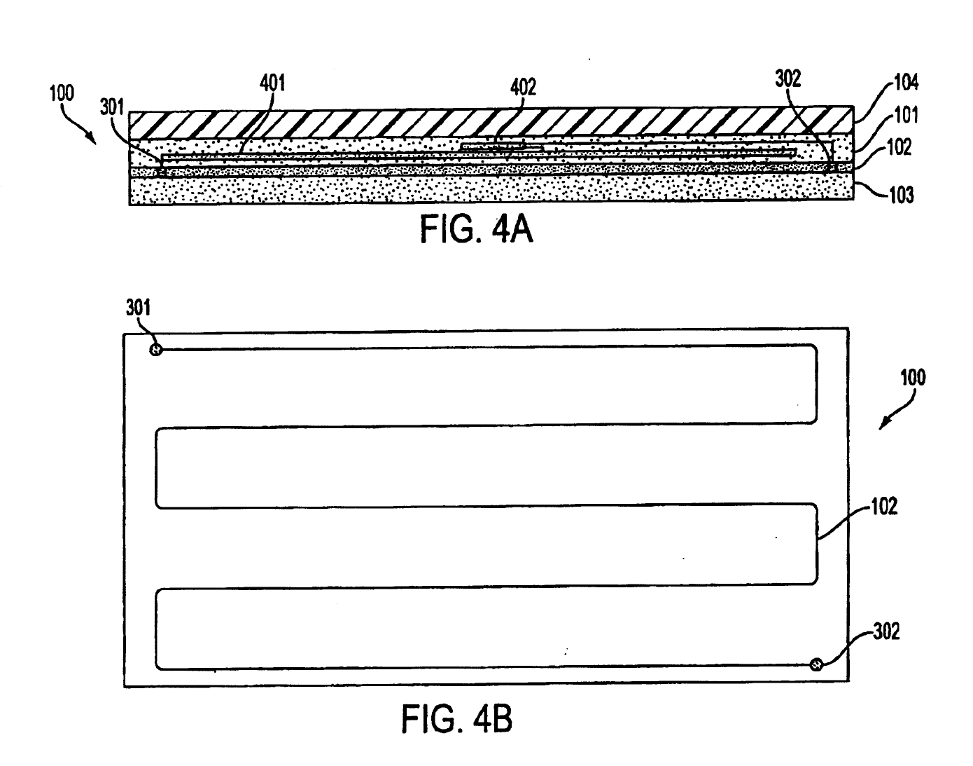

FIGS. 4 to 7 are schematic illustrations of further preferred embodiments of the tamper indicating RFID label 100, showing both a cross sectional view and a view looking from below through the adhesive layer 103 at the tamper tracks 102.

FIGS. 4A and 4B are schematic illustrations of a preferred embodiment in which the tamper track 102 connects the points 301 and 302 and is in series with an induction loop 401 in the RFID layer 101. The RFID layer 101 may include the induction loop 401 and other components 402, which may be passive or active. For example, the components 402 in one embodiment may be a capacitor which, with the induction loop 401, forms a resonant electrical circuit. Alternatively, the components 402 may include a passive electronic memory chip for storing data. The tamper track 102 should be intact for the RFID label 100 of FIG. 4 to be operational. When the label 100 is tampered, the tamper track 102 is broken or disrupted and the RFID function of the label 100 can be disabled or modified. In this way it can be determined whether or not the label 100 has been tampered. An adhesion modifying coating may be included, as described above, to enhance destructibility of the tamper tracks 102.

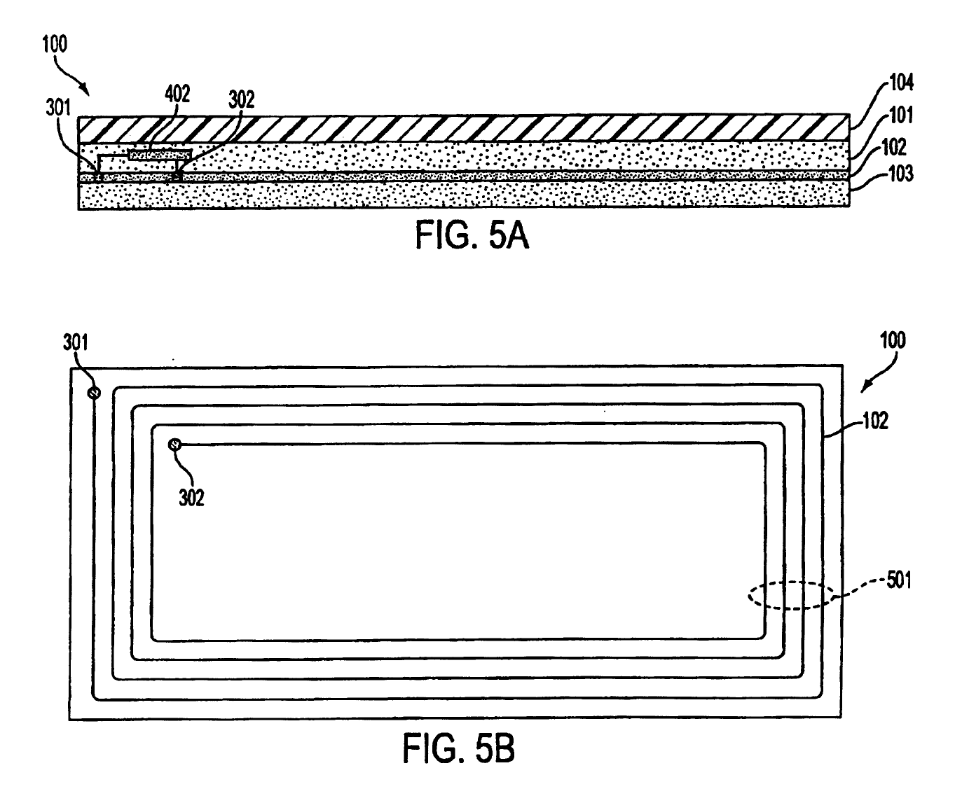

FIGS. 5A and 5B are schematic illustrations of another preferred embodiment in which the tamper track 102 forms an induction loop 501 for the RFID label 100. In FIG. 5, the through-connect points 301 and 302 are connected to the RFID components 402 in the layer 101. In connecting the points 301 and 302, the tamper track 102 forms a number of loops, with the overall layout of the tamper track 102 acting as an induction loop. Tampering or removing the label 100 results in a break in or disruption to the tamper track 102, thereby disabling or modifying the RFID function of the label 100. In this way it can be determined whether or not the label 100 has been tampered. An adhesion modifying coating may be included, as described above, to enhance destructibility of the tamper tracks 102.

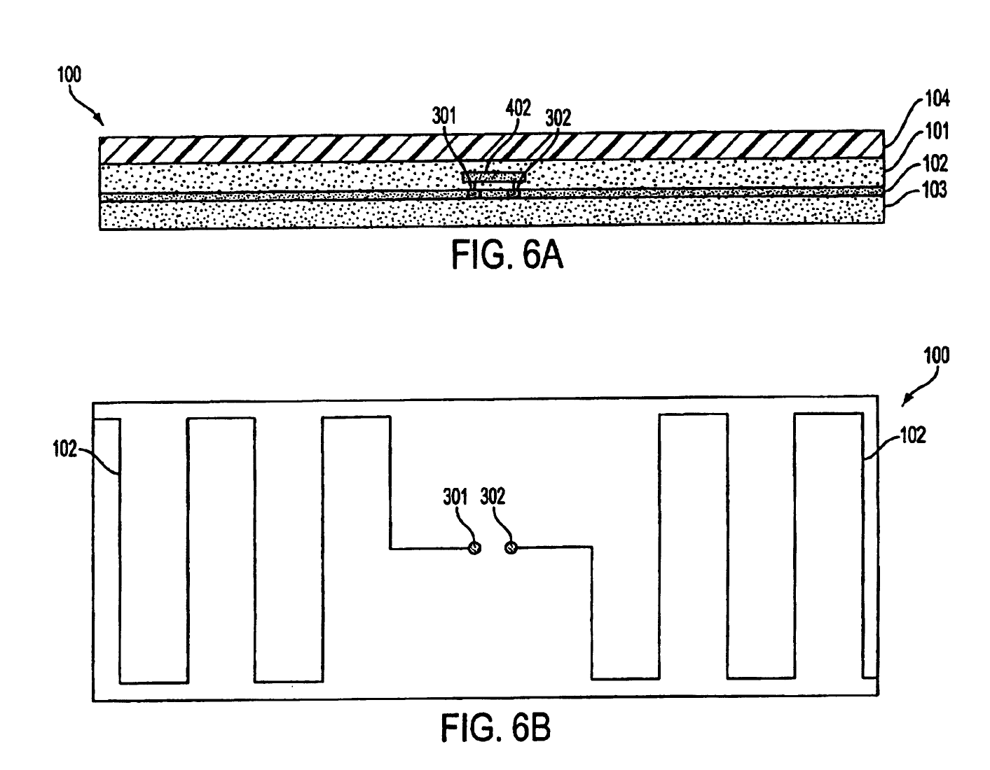

FIGS. 6A and 6B are schematic illustrations of another preferred embodiment, which is a variation on the embodiment of FIG. 5. In FIG. 6, the tamper tracks 102 form an antenna, whereas in FIG. 5 the tamper track 102 forms an induction loop. The principal difference is that in FIG. 6 the points 301 and 302 are not connected together by a single tamper track 102. Instead there are two tamper tracks 102, one starting at point 301 and the other starting at the point 302. The two tamper tracks 102 form an antenna. In FIG. 6 a so-called meander antenna is illustrated, although it should be appreciated that other forms of antenna may also be employed. In some antenna designs the points 301 and 302 may be connected to each other by the tamper track 102. In FIG. 6 the through-connect points 301 and 302 are connected to the RFID components 402. Tampering the label 100 should result in damage to at least one of the tamper tracks 102, thereby affecting the characteristics of the antenna and modifying or disabling the RFID function of the label 100. In this way it can be determined whether or not the label 100 has been tampered. An adhesion modifying coating may be included, as described above, to enhance destructibility of the tamper tracks 102.

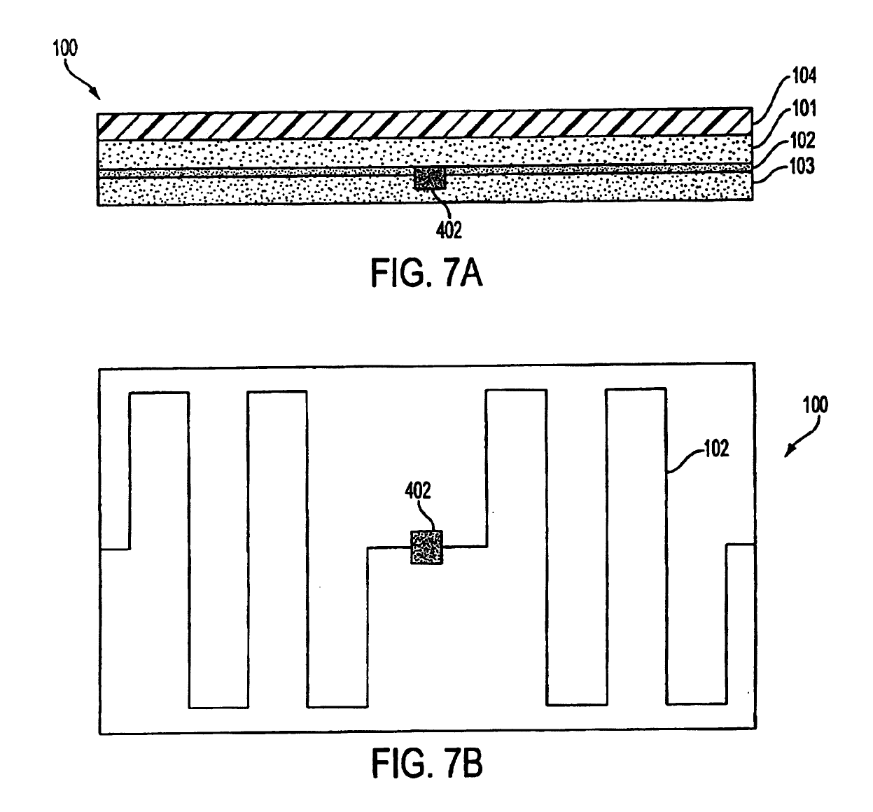

FIGS. 7A and 7B are schematic illustrations of another preferred embodiment, based on the embodiments of FIGS. 5 and 6. The principal difference between the designs illustrated in FIGS. 5 and 6, and the design illustrated in FIG. 7 is that in the design of FIG. 7 the RFID components 402 are on the underside of the layer 101. In some embodiments, the RFID components 402 may comprise only an RFID memory chip, in which case in the design of FIG. 7, both the RFID memory chip 402 and the tamper tracks 102 are on the underside of the layer 101. The tamper tracks are designed to be destructible, as described herein. An advantage of the design of FIG. 7 compared with the designs of FIGS. 5 and 6 is that in the design of FIG. 7 there is no need for through-connects to the bottom side of the layer 101, since the RFID components 402 are on the bottom side of the layer 101. In the design of FIG. 7 the tamper tracks 102 may form an induction loop, as in the design of FIG. 5, or may form an antenna, as in the design of FIG. 6. In FIG. 7 an antenna is shown. An adhesion modifying coating may be included, as described above, to enhance destructibility of the tamper tracks 102.

In order to provide an additional indicator of tampering, the label 100 may be designed to show visual evidence of tampering if the label is removed from a surface to which it has been applied. Visual tamper indication can be achieved in several ways. In one embodiment, a thin colored layer is applied to the underside of the RFID layer 101. A pattern of an adhesion-modifying layer may be applied to the underside of the colored layer. The adhesion-modifying layer may be the same layer or a layer in addition to the adhesion modifying coating described above. The presence of the adhesion-modifying layer modifies the adhesion of the colored layer to the adhesive layer 103 such that when the label 100 is removed from a surface to which it has been applied, the colored layer breaks up. Areas of color may adhere to the adhesive layer 103 and other complementary areas of color may adhere to the RFID layer 101. An alternative to this embodiment is to apply a pattern of the adhesion modifying layer directly to the underside of the RFID layer 101 and apply the thin colored layer to the underside of the adhesion modifying layer. In another embodiment, the adhesion modifying coating may be applied directly to the underside of the RFID layer 101 and a colored adhesive can be used as the adhesive layer 103. In this case, when the label is removed from a surface to which it has been applied, the colored adhesive 103 should break up and areas of the colored adhesive may adhere to the RFID layer 101 and complementary areas of the colored adhesive 103 may adhere to the surface to which the label is applied. It should be appreciated that other methods may be used to produce a visual tamper indicating effect.

When using a visual tamper indicating effect, a portion of the RFID layer 101 and top coat 104 (if a top coat 104 is present) should be transparent so the visual effect can be seen by looking through the RFID layer 101 and top coat 104. This enables easy inspection of the visual tamper indicating feature without having to remove the label. The RFID components in the RFID layer 101, such as a memory chip, may not be transparent, but should only occupy a small portion of the surface area.

Additionally, it may be desired to print information or patterns on the label. For example, as described above, a bar code or serial number may be printed on the top surface of the RFID layer 101 or on the top surface of the top coat 104 (if a top coat 104 is present). Enough of the RFID layer 101 and top coat 104 should be transparent to allow the visual tamper indicating feature to be visible.

Method of Manufacture

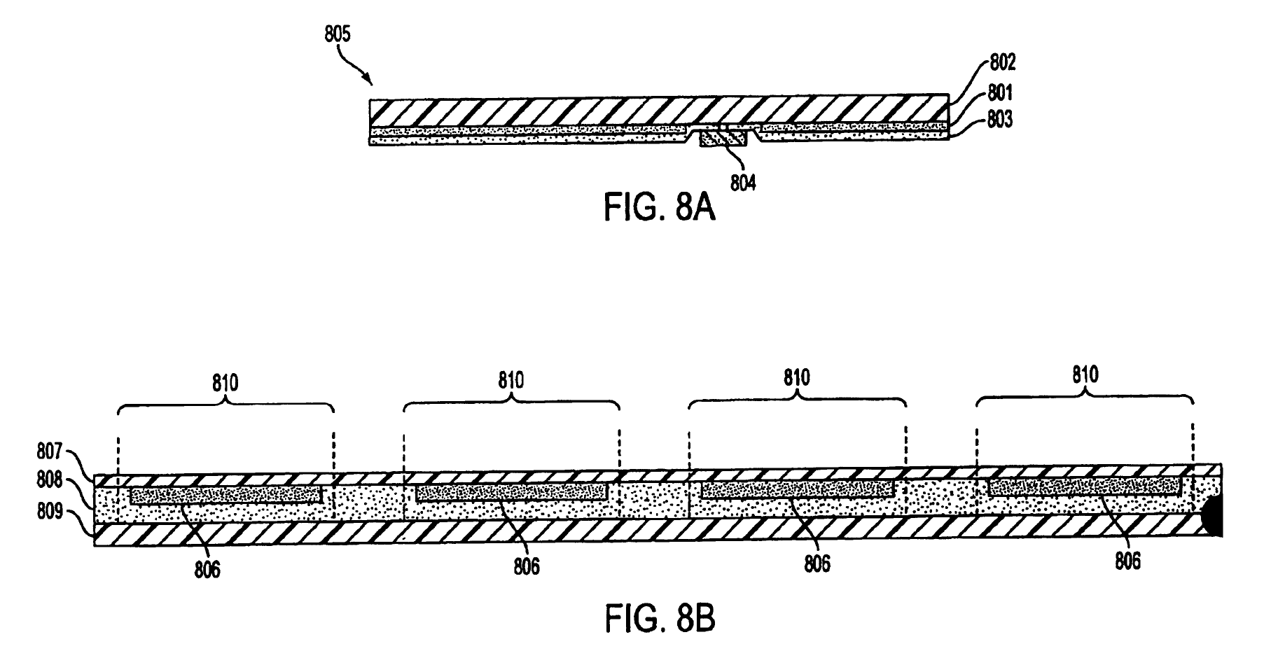

A preferred method of manufacture for the label configuration described above in relation to FIG. 7 is now described and illustrated schematically in FIG. 8, which shows illustrations of an RFID label construction and method of manufacture in cross sectional view.

The diagram of FIGS. 8A and 5B illustrates a passive RFID label construction, in which the RFID components 402 consist of an RFID electronic memory chip.

A pattern 801 of adhesion modifying coating may be applied to the underside of a substrate layer 802, which may in one embodiment be a polyester layer. The tamper tracks 803 can be printed on the underside of the adhesion modifying coating. If necessary the tamper tracks can include a “cross-over”, where a tamper track 803 crosses over itself along a bridging layer of electrical insulator. The tamper tracks 803 may be configured to form either an induction loop or antenna of appropriate design and characteristics. An RFID electronic memory chip 804 can then be mounted on the underside of the layer 802 and positioned to connect to appropriate terminating points on the tamper tracks 803. The RFID chip 804 and tamper tracks 803 should form an RFID transponder. The construction 805 consisting of substrate 802, adhesion modifying coating 801, tamper tracks 803 and RFID chip 804 is cut into individual transponders 806. Each transponder 806 is placed in a specified position on the underside of a top coat layer 807 and may be fixed in position with a thin adhesive layer. A layer of pressure sensitive adhesive 808 may be applied to the underside of the top coat 807 and individual transponders 806. The resulting construction consisting of top coat layer 807, individual transponders 806 and adhesive layer 808 is mounted on a suitable carrier film 809 and produced in roll form. The resulting roll is die cut into individual labels 810 mounted on the continuous carrier film 809, where each label 810 includes one transponder 806.

In a variation on the method of manufacture illustrated in FIG. 8, the tamper tracks 803 may be produced using an electrically conducting adhesive instead of an electrically conducting ink.

The method of manufacture described in relation to FIG. 8 may also be employed in the manufacture of tamper indicating RFID labels based on other configurations of electronic memory chip, antenna or induction loop, and tamper track.

Tamper Indicating RFID Label with Tracking Capability

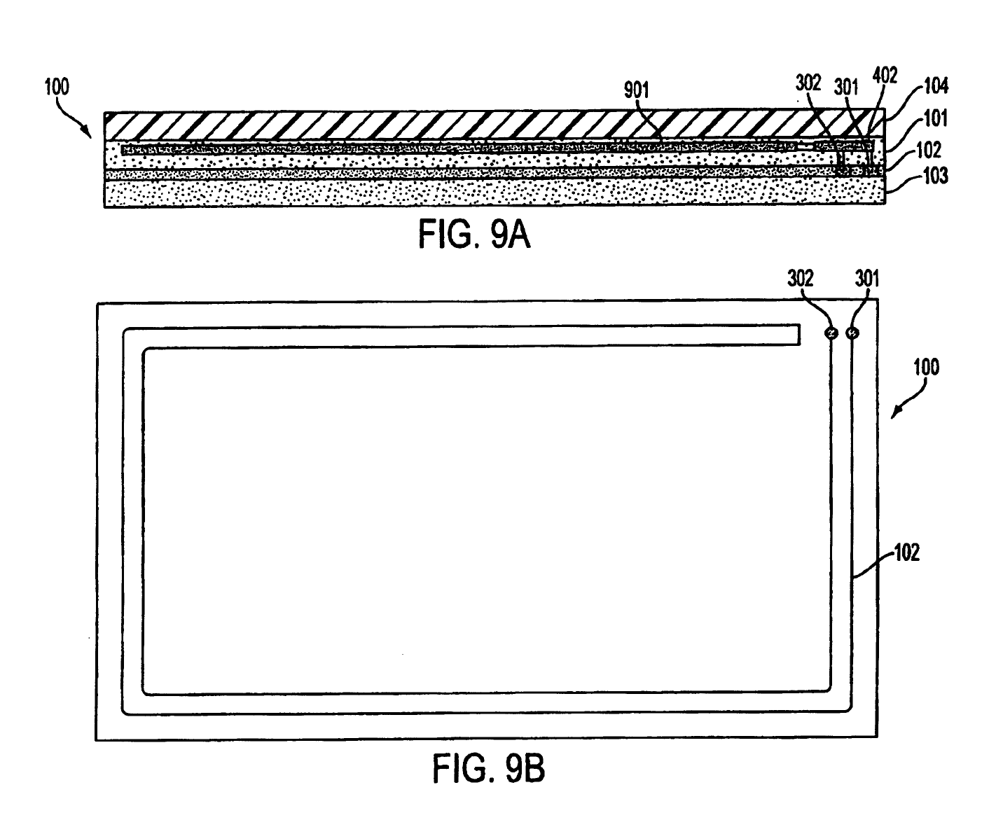

FIGS. 9A and 9B are schematic illustrations of another preferred embodiment in which the tamper track 102 forms part of a separate tamper indicating electrical circuit. As shown in FIG. 9, the RFID layer 101 may contain an induction loop or antenna 901 and other electronic components 402, including an electronic memory chip, to provide an RFID capability. The RFID layer 101 should be capable of interacting with an RFID reading device to allow reading of or modification to data stored in the electronic memory chip. The through-connect points 301 and 302 are connected to the components 402 in the layer 101, and to each other via the tamper track 102. The components 402 should be configured to respond differently to a signal from an RFID reader depending on whether or not the points 301 and 302 are connected to each other via the tamper track 102. If the tamper track 102 is intact, the label 100 will respond in a specified manner to an RFID reader. On the other hand, if the label 100 is tampered, so that the tamper track 102 is damaged and connection between the points 301 and 302 via the tamper track 102 is disrupted, the label 100 should still respond to an RFID reader, but in a different manner, thereby indicating that the label 100 has been tampered. In this way, the label 100 of FIG. 9 can provide an RFID-based means to (i) determine whether the label 100 is present, (ii) read data from the label 100 and modify data stored in the label 100, and (iii) determine whether the label 100 has been tampered. In one preferred embodiment the components 402 may consist only of a passive RFID electronic memory chip, and the tamper track 102 forms a connection, which may be separate from the induction loop or antenna 901, between two contact points on the memory chip.

In a variation on the embodiments described above, the components 402 may undergo an irreversible change if the label 100 is tampered and the tamper track 102 is damaged, so that even if the tamper track 102 is subsequently restored, the label 100 will still respond to an RFID reader with a signal indicating it has been tampered. In one preferred embodiment the RFID components 402 is “active” (i.e. powered) and is configured to test the integrity of the tamper track 102 either continuously or at specified intervals. In this embodiment, if the RFID components 402 detect that the tamper track 102 has been disrupted, they may then preferably be configured to record data to this effect in the electronic memory chip within the components 402, preferably in a manner which is permanent and irreversible. Preferably, if the components 402 are active, they may also include a clock. In this case, the date and time of any tampering of the tamper track 102 or label 100 may also be recorded permanently and irreversibly in the electronic memory chip within the RFID components 402.

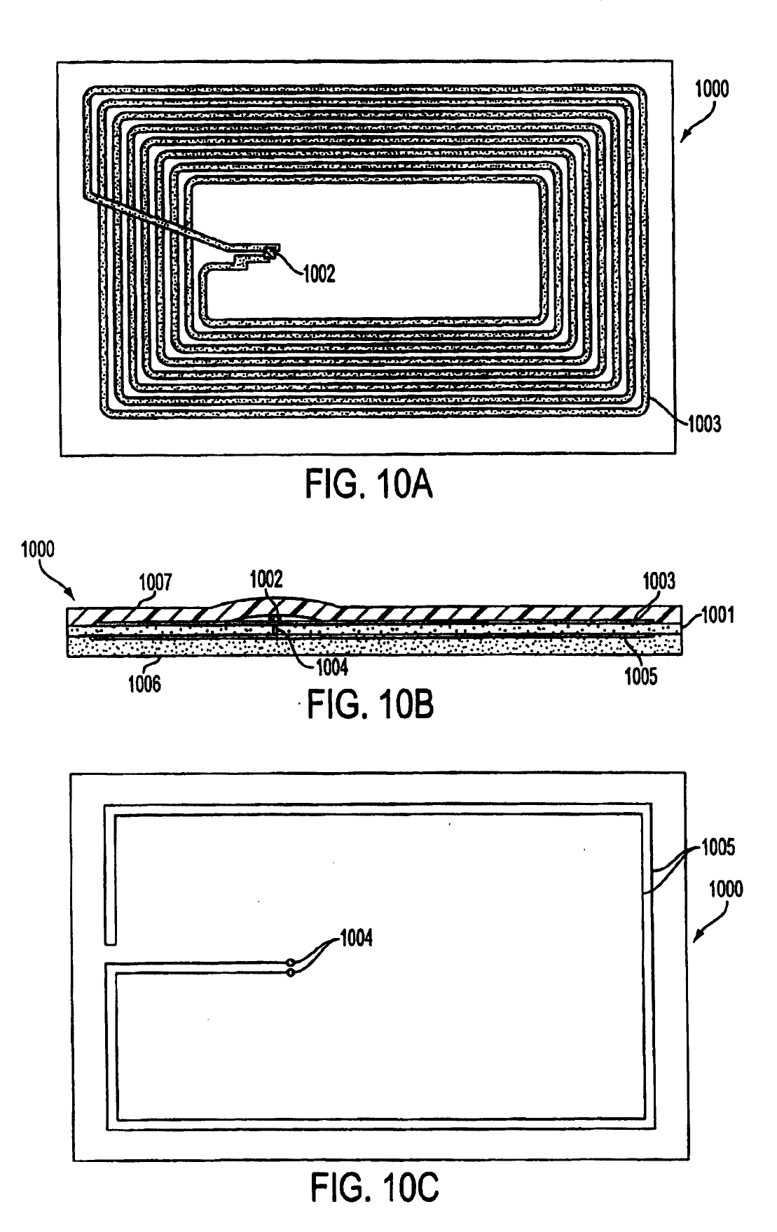

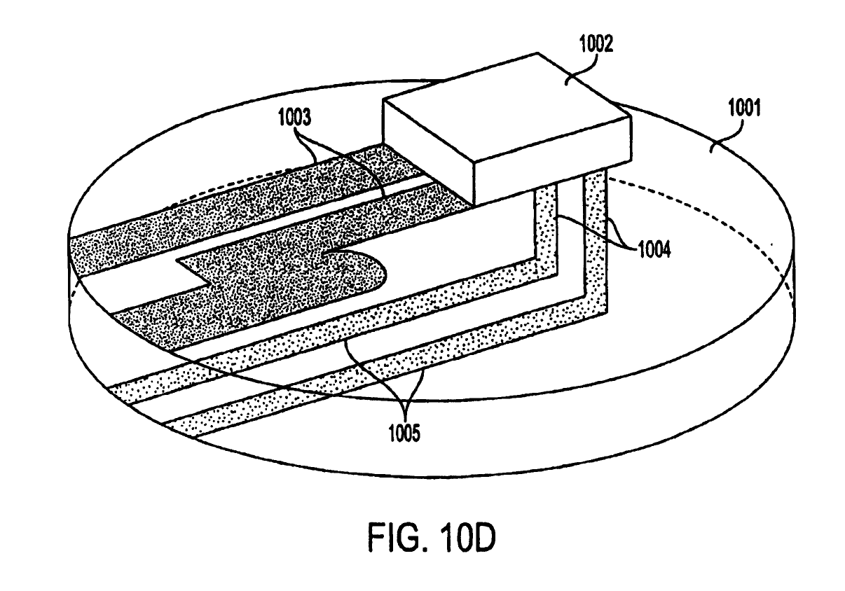

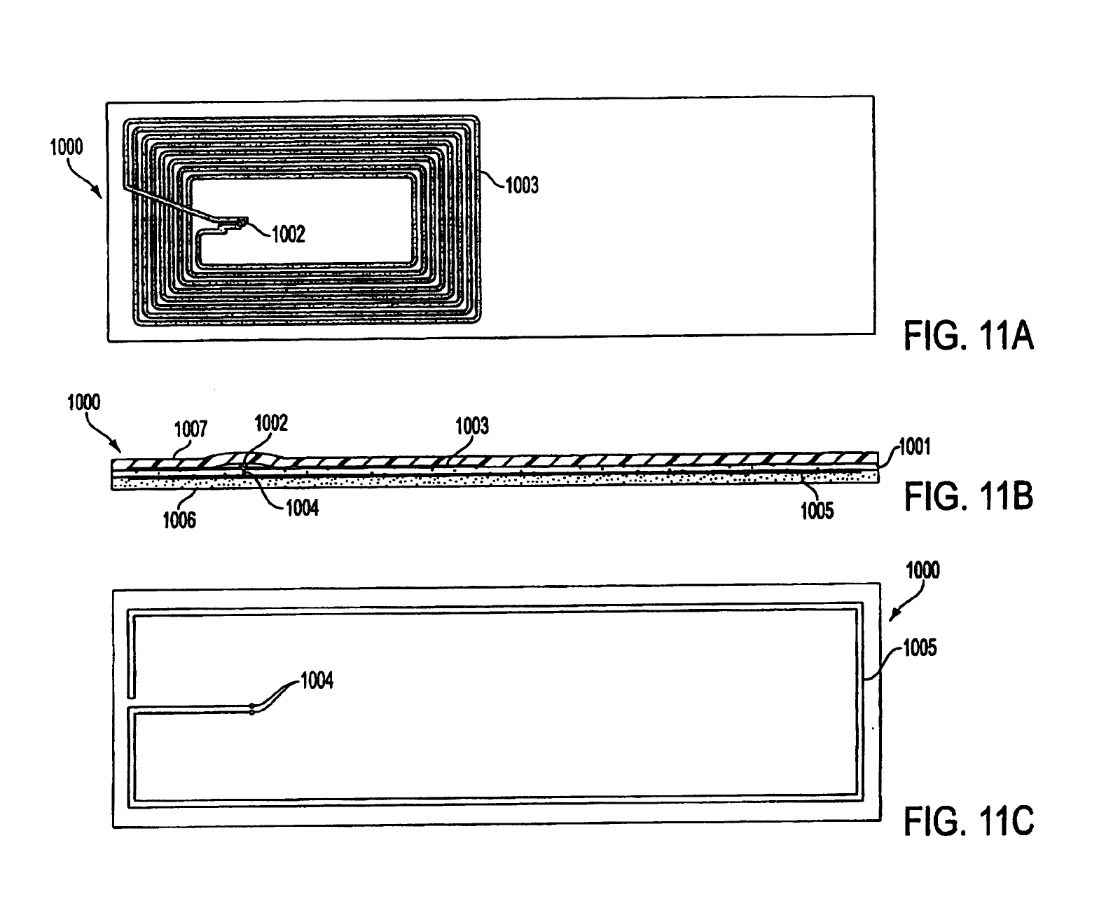

A preferred embodiment of the tamper indicating RFID label configuration of FIG. 9 will now be described by way of non-limiting example with reference to the schematic illustrations shown in FIGS. 10 and 11.

It should be appreciated that the term antenna as used below may refer to a conventional antenna or to an induction loop (which is used as an antenna at some RFID operating frequencies).

FIG. 10 is a schematic illustration of a tamper indicating RFID label 1000 shown in top view (10A), cross sectional side view (10B), and bottom view (10C).

The label 1000 may include a substrate layer 1001 made of, for example, polyester or some other suitable material. On top of the substrate layer 1001, electronics to form an RFID transponder, which provides an RFID function, may be applied. The electronics may include an RFID electronic memory chip 1002 and an antenna 1003. (In FIG. 10 an antenna 1003 in the form of an induction loop is shown.)

FIG. 10D is a more detailed schematic illustration of an example of the electrical connections to the electronic chip 1002.

The chip 1002 and antenna 1003 should provide an RFID capability, which may include the ability to store information in the chip 1002, the ability to read information from the chip 1002 at a distance using a suitable RFID device, and the ability to modify information in the chip 1002 from a distance using a suitable RFID device.

The chip 1002 may include two contact points, or contact pads, connected to the antenna 1003, as illustrated in FIG. 10D.

Two contact pads on the chip 1002 may be connected via electrical “through-connects” 1004 to the underside of the substrate layer 1001. One or both or neither of these two contact pads may be the same as the contact pads used to connect the chip 1002 to the antenna 1003. FIG. 10D shows the through-connects 1004 directly beneath the chip 1002. It should be appreciated that other configurations may instead be used for the through-connects 1004. In another preferred embodiment, the through-connects 1004 may be positioned away from the contact pads on the chip 1002, and electrical tracks on the top surface of the substrate layer 1001 connect contact pads on the chip 1002 to the tops of the through-connects 1004.

The two through-connect points 1004 on the underside of the substrate layer 1001 are connected to each other by means of a tamper track 1005, which is positioned on the underside of the substrate layer 1001.

A layer of adhesive 1006 may also be applied to the underside of the substrate layer 1001 and tamper track 1005. Preferably the adhesive 1006 is a pressure sensitive adhesive.

A top layer 1007 may be applied over the top of the substrate 1001, chip 1002 and antenna 1003. The top layer 1007 can provide protection for these is components and can also provide a surface to accept printing—for example printing of a number, a barcode, a logo, or other image.

It should be appreciated that in FIGS. 10A-10C the top view is a view looking through the top layer 1007, the side view is a cross sectional side view, and the bottom view is a view looking though the adhesive layer 1006.

The tamper track 1005 is preferably applied to the underside of the substrate layer 1001 along with one or more layers of adhesion modifying coating to enhance the destructibility of the tamper track 1005. Consequently, if the label 1000 is applied to a surface and subsequently removed, the tamper track 1005 should be broken or disrupted so as to interrupt or disrupt the electrical connection between the through-connect points 1004 on the underside of the substrate layer 1001. Application of the tamper track 1005 and any adhesion modifying coatings to the underside of the substrate 1001 to enhance the destructible nature of the tamper track 1005 may preferably be carried out as described herein and in the following patent applications, which are incorporated by reference:

“Materials and Construction For A Tamper Indicating Radio Frequency Identification Label”; PCT Application No. PCT/US01/23639, filed Jul. 27, 2001; U.S. application Ser. No. 09/915,760, filed Jul. 26, 2001; and

“Tamper Indicating Radio Frequency Identification Label with Tracking Capability”, U.S. Provisional Application Serial No. 60/249,027, filed Nov. 15, 2000.

The tamper track 1005 may be laid out in a number of different ways on the underside of the substrate layer 1001. In the preferred embodiment illustrated in FIG. 10, the tamper track runs from one through-connect point 1004 almost all the way around the perimeter of the underside of the substrate layer 1001 and then back to the other through-connect point, with the outward and return paths of the tamper track 1005 very close together in order to avoid any electrical induction effects which may interfere with the antenna 1003 positioned above on the upper surface of the substrate layer 1001. The width and thickness of the tamper track 1005 can be adjusted to provide the correct properties in terms of electrical resistance and physical destructibility. The path made by the tamper track 1005 may run inside, or outside, or directly beneath the antenna 1003, which in FIG. 10 is an induction loop. In one preferred embodiment the tamper track 1005 forms a path which is outside the outer perimeter of the induction loop 1003, thereby ensuring that any disturbance around the perimeter of the label 1000 will cause the tamper track 1005 to be disrupted.

When the label 1000 is applied to a surface, the tamper track 1005 is intact and the corresponding contact pads on the chip 1002 are electrically connected to each other. When the label 1000 is removed or substantially tampered with, the tamper track 1005 should be broken or disrupted and there will then be an open circuit or increased electrical impedance between the corresponding contact pads on the chip 1002. When such an open circuit or increase in impedance occurs, the function of the RFID chip 1002 or the information stored in the chip 1002 will be modified in a way which can be detected by an RFID reader.

If the label 1000 is passive (i.e. without an on-board battery or other power source), the modified chip function or information can be detected during the first read operation of the label after the label 1000 is removed or tampered, and the reader (if it has a write capability) can be programmed to write data back to the chip 1002 to indicate that the label 1000 has been removed or tampered. The data which is written back to the chip 1002 to indicate removal or tampering of the label 1000 is preferably permanent and irreversible, to prevent the memory contents of the chip being altered back to the original state to disguise the fact that the label has been moved or tampered. There is therefore disclosed herein an RFID read/write device capable of detecting the change in RFID performance of the label 1000 when the label 1000 is tampered, and writing data back to the chip 1002 within the label 1000 to indicate such tampering has occurred, the data preferably being written into the chip 1002 so as to be permanent and irreversible.

In one preferred embodiment, specified electrical properties (such as the electrical impedance) of the connection between the through-connect points 1004 via the tamper track 1005 are monitored during an RFID read operation, and presented to the reader as data values in a specified memory area of the chip 1002. A suitably configured RFID read/write device will read the data values, and thereby determine whether or not the label 1000 is tampered, according to whether or not the data values fall within a specified range. If the data values are such as to indicate tampering, the RFID read/write device will write back to another specified memory area of the chip 1002 a set of data values to indicate the label 1000 has been tampered, with the written-back data values preferably being permanently recorded in the chip 1002.

If the label 1000 is active (i.e. has an on-board battery or other power source), it may be configured such that any disruption to the tamper track 1005 can be detected internally within the label 1000 without requiring an RFID read operation. When such disruption to the tamper track 1005 is detected internally, the chip 1002 can be programmed to modify its own memory contents to indicate that the label 1000 has been tampered. The modification to the memory contents of the chip 1002 to indicate removal or tampering of the label 1000 should preferably be permanent and irreversible, to prevent the memory contents of the chip being altered back to the original state to disguise the fact that the label has been moved or tampered.

Hence the label 1000 may function as a normal RFID label when it is first applied to a surface. After the label is moved or tampered, the RFID function of the label 1000 will be maintained and information can be read from and written to the RFID chip 1002, while the label also provides an RFID means to determine that it has been moved or tampered.

FIGS. 11A-11C are variations on the preferred embodiment of FIGS. 9 and 10. The basic design of the label 1000 in FIG. 11 is similar to that of FIG. 10. The difference in the design of FIG. 11 is that the tamper track 1005 extends well beyond the antenna 1003 or other RFID components in at least one direction. The tamper track 1005 should preferably run around the perimeter of the label 1000 in order to detect tampering of any edge portion of the label, whether near the chip 1002 and antenna 1003 or at the end of the label away from these components. The label 1000 can, for example, be applied around a corner so that the chip 1002 and antenna 1003 are on a flat surface while the other end of the transponder, which includes the tamper track 1005, extends around the corner.

Loop Tag

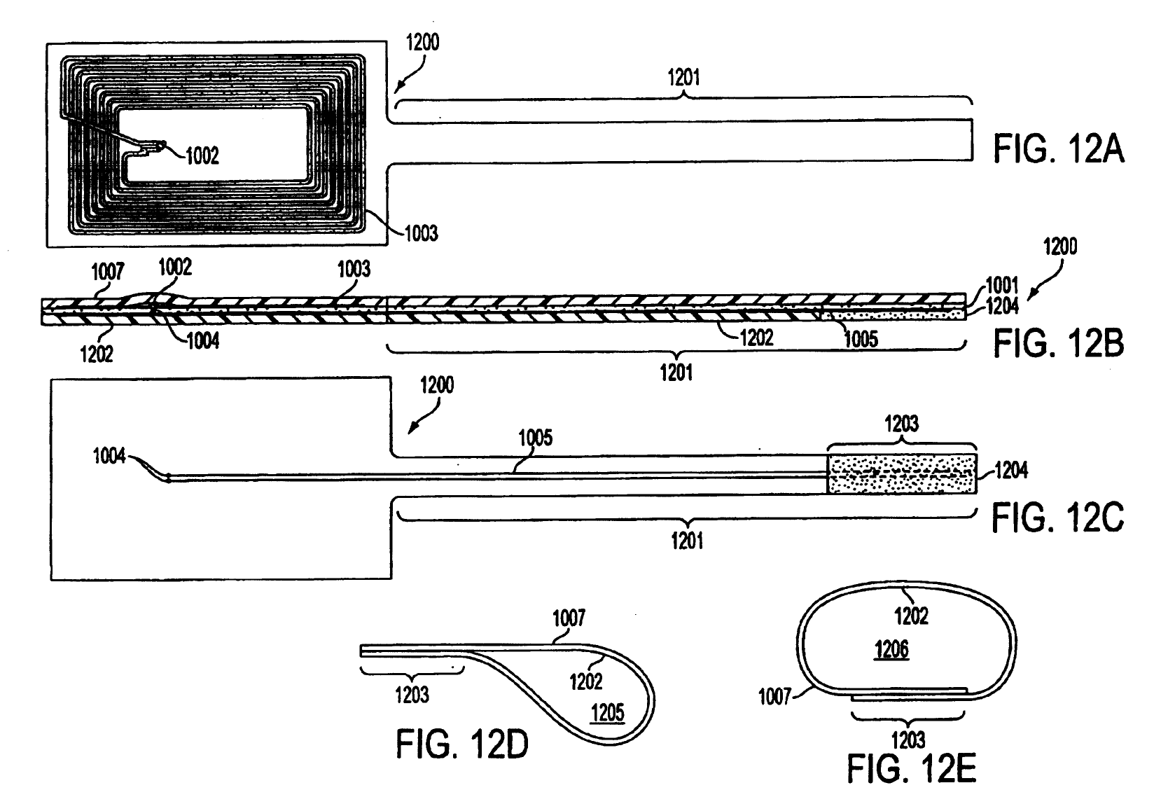

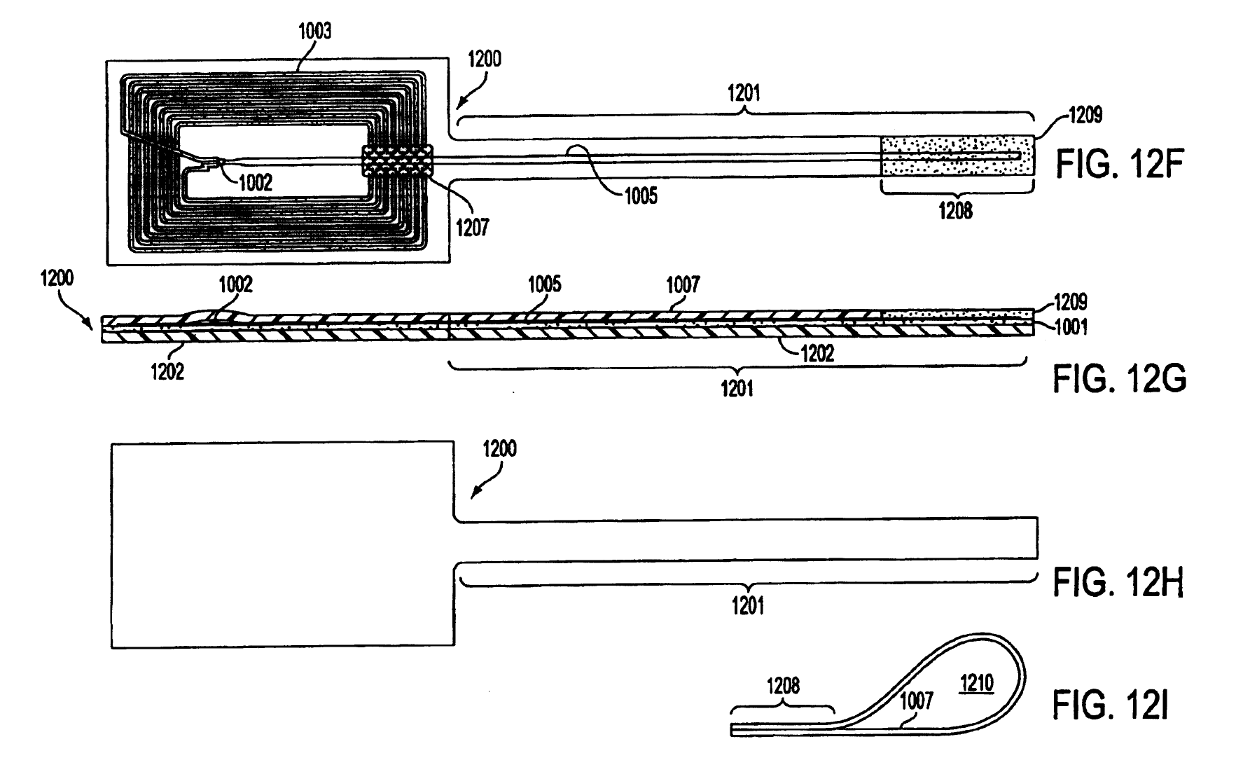

FIGS. 12A-12I are another variation on the embodiment of FIGS. 10 and 11. FIG. 12 is a schematic illustration of a tamper indicating RFID loop tag 1200, shown in top view (12A), side view (12B) and bottom view (12C).

In FIG. 12, the tamper track 1005 on the underside of the substrate 1001 extends beyond the antenna 1003 and forms a “tail” 1201. In the embodiment shown in FIG. 12, the tamper track 1005 is straight. The substrate 1001 may be cut approximately to the shape of the electronics, so that the loop tag 1200 is broad at the end which includes the antenna 1003 and narrow at the tail 1201. Alternatively, the loop tag may be cut into any other shape around the electronic components. Preferably, the tamper track 1005 will extend to the end of the tail 1201.

A bottom layer 1202 may be applied to a specific portion of the underside of the substrate 1001 and tamper track 1005. The tamper track should extend into the region 1203 of the underside of the substrate 1001 that is not covered with the bottom layer 1202. In the region 1203 where the bottom layer 1202 is not applied, an adhesive, such as a pressure sensitive adhesive 1204, may be applied to the underside of the substrate 1001 and the tamper track 1005.

A top layer 1007 may be applied over the top of the substrate 1001, chip 1002 and antenna 1003. The top layer 1007 may provide protection for these components and may also provide a surface to accept printing—for example printing of a number, a barcode, a logo, or other image.

It should be appreciated that in FIG. 12 the top view is a view looking through the top layer 1007 to the chip 1002 and antenna 1003, and the bottom view is a view looking through the bottom layer 1202 and adhesive 1204 to the tamper track 1005 and through-connects 1004.

In operation, the loop tag 1200 may be bent into a loop 1205 and the region 1203 of pressure sensitive adhesive can be pressed against a region of the bottom layer 1202, as shown. The pressure sensitive adhesive 1204 should be strong enough to hold the loop 1205 closed. In another variation, a loop 1206 may be formed by pressing the region 1203 of pressure sensitive adhesive 1204 against a region of the top layer 1007, as also shown. (It should be noted that the illustrations of the loops 1205 and 1206 do not show the internal components such as the chip 1002, antenna 1003 and tamper track 1005—or the separate layers of the loop tag construction.) The two regions of the loop tag which are joined together in this way by the pressure sensitive adhesive 1204 preferably both include electronics—for example, the chip 1002, or the antenna 1003, or the tamper track 1005—in order to ensure the closed loop cannot be cut and the loop opened without the RFID performance of the loop tag 1200 being affected. For example, the tamper track tail 1201 may be looped back-and fixed to another portion of the tamper track tail 1201 or may be looped back and fixed to a region of the underside of the antenna 1003 (as illustrated in the loop 1205). The substrate 1001, pressure sensitive adhesive 1204, tamper track 1005, and any adhesion modifying coatings which are applied (as described in relation to FIGS. 9 and 10), are preferably designed as described herein such that the tamper track 1005 is damaged when the closed loop is pulled apart in the region of pressure sensitive adhesive 1204, thereby modifying the RFID performance of the loop tag 1200, as described above in relation to the label constructions of FIGS. 9 and 10. A similar modification to the performance of the loop tag 1200 will occur if the closed loop 1205 or 1206 is cut in order to open the loop. In some preferred embodiments, the region of the loop tag against which the area 1203 is applied to close the loop may also include an adhesive layer, in order to strengthen the adhesive bond when the loop is closed, and the adhesive layer may be in direct contact with electronics on the substrate 1001.

A variation on the embodiment shown in FIGS. 12A to 12E is illustrated in FIGS. 12F to 121. In this variation the tamper track 1005 is on the top side of the substrate 1001—i.e. on the same side of the substrate as the chip 1002 and antenna 1003. An electrically insulating region 1207 is applied between the antenna 1003 and tamper track 1005 to prevent electrical contact. In the embodiment illustrated in FIGS. 12F to 12H, the tamper track is exposed in the region 1208 on the top surface of the substrate 1001. An adhesive coating 1209—preferably a pressure sensitive adhesive—is applied to region 1208 where the tamper track 1005 is exposed. In operation, the loop tag 1200 illustrated in FIGS. 12F to 12H may be bent into a loop 1210, as shown in FIG. 121, and the region 1209 of pressure sensitive adhesive can be pressed against a region of the top layer 1007, as shown. (It should be noted that the illustration of the loop 1210 does not show the internal components—such as the chip 1002, antenna 1003 and tamper track 1005—or the separate layers of the loop tag construction.) The pressure sensitive adhesive 1209 should hold the loop 1210 closed. The two regions of the loop tag which are joined together in this way by the pressure sensitive adhesive 1209 preferably both include electronics—for example, the chip 1002, or the antenna 1003, or the tamper track 1005—in order to ensure the closed loop cannot be cut and the loop opened without the RFID performance of the loop tag 1200 being affected. In some preferred embodiments, the region of the loop tag against which the area 1208 is applied to close the loop may also include an adhesive layer, in order to strengthen the adhesive bond when the loop is closed, and the adhesive layer may be in direct contact with electronics on the substrate 1001.

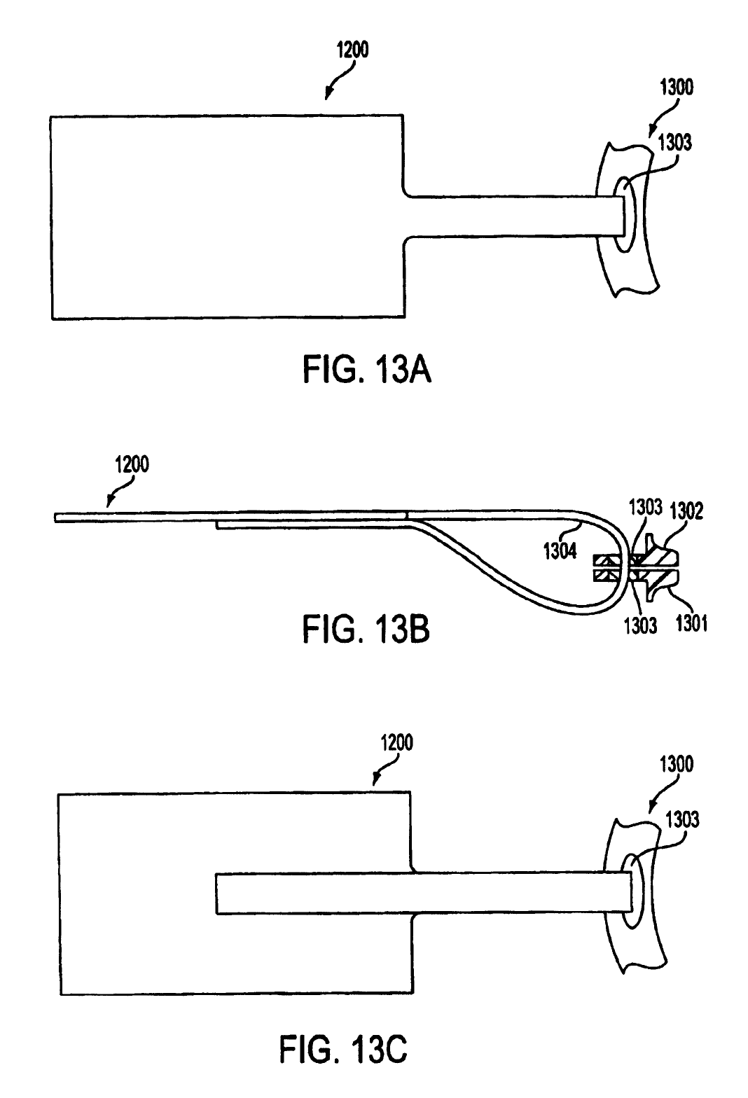

The loop tag configuration illustrated in FIG. 12 may be used to secure the tag 1200 around an item such as a handle, or to secure two items together. FIGS. 13A-13C are schematic illustrations of the use of the loop tag 1200 to detect opening of a container 1300 which includes a body 1301 and lid 1302. The body 1301 and lid 1302 have holes 1303 which align when the lid 1302 is placed properly on the body 1301 of the container 1300. FIG. 13B shows a cutaway cross sectional view of a portion of the body 1301 and lid 1302 of the container 1300 in the region of the holes 1303. In this embodiment, the loop tag 1200 is applied to the container 1300 with the open loop portion 1304 passing through the aligned holes 1303. In this implementation, the RFID chip 1002 in the loop tag 1200 may store information about the contents of the container 1300. If the loop tag 1200 is removed from the container 1300, either by pulling the loop apart to open the loop or by cutting the loop tag, the tamper track 1005 will be interrupted and the RFID performance of the loop tag 1200 will be modified in a manner detectable by an RFID reader, as described above in relation to the label construction of FIGS. 9 and 10.

It should be appreciated that the loop tag 1200 does not need to have a narrow tail region. The loop tag may instead be rectangular in shape.

The Tamper Track

It should be appreciated that the tamper tracks described herein may be made from a number of different materials. In general, the tamper tracks should have appropriate electrical properties (in particular their electrical impedance should fall within a specified range), but in at least some regions the tamper tracks should not have high intrinsic physical strength, thereby facilitating damage or disruption to the tamper tracks when a tamper indicating RFID label is tampered.

It should be appreciated that a tamper track may be made from more than one material, in order to achieve the required combination of electrical and mechanical properties. Two examples of embodiments of such tamper tracks are now described, but it should be appreciated that other embodiments are possible. In the first embodiment, a tamper track is made from regions of solid metal conductor, such as Copper or Aluminum, with these regions being electrically connected in sequence by regions of electrically conducting ink, the combination thereby forming a tamper track. In the second embodiment, a region of thin (and therefore mechanically weak) solid metal conductor, such as Copper or Aluminum, is overlaid with a layer of electrically conducting ink, thereby forming a tamper track.

Further Embodiments of the Tamper Indicating RFID Label

It should be appreciated that variations on the embodiments of FIGS. 9 to 12 are possible. For instance, taking the design of FIG. 10 as an example, the chip 1002, antenna 1003 and tamper track 1005 may all be on the underside of the substrate 1001. The antenna 1003 may be made from a solid metal conductor, such as Copper or Aluminum, to provide strength and durability, while the tamper track 1005 may include at least some portions which are designed to be destructible upon tampering of the label 1000. It may be necessary for the tamper track 1005 to cross over the antenna 1003 in order to extend outside the antenna, in which case a layer of electrically insulating material will be applied between the antenna 1003 and tamper track 1005 in the cross-over region. The advantage of this embodiment is that the electrical through-connects 1004 described in relation to the designs of FIGS. 9 and 10 are not required.

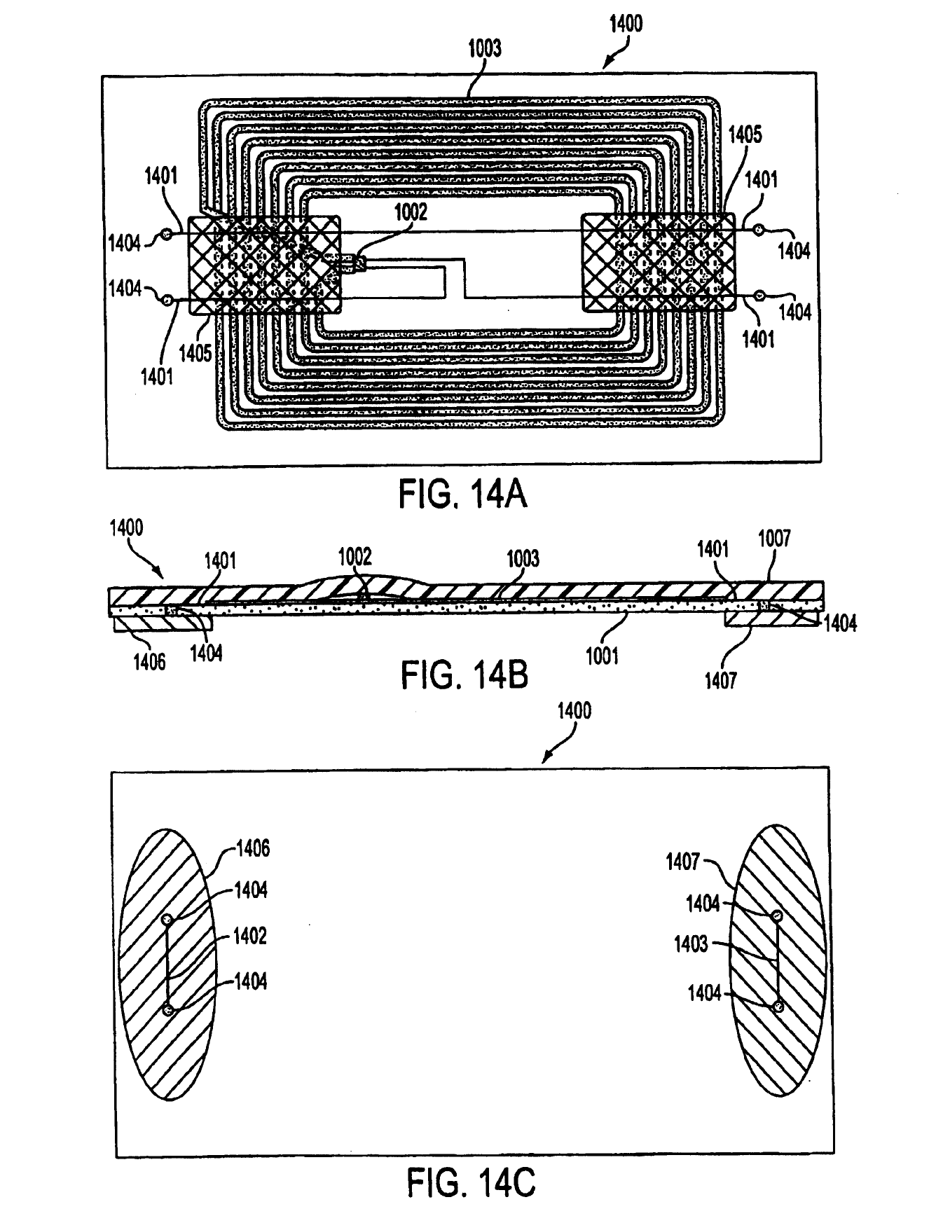

FIG. 14 shows a tamper indicating RFID label 1400, which is a variation on the embodiment of FIG. 10. FIG. 14 shows the label 1400 in top view (14A), cross-sectional side view (14B), and bottom view (14C). A difference between the embodiment of FIG. 10 and the embodiment of FIG. 14 is that in FIG. 14 a substantial portion 1401 of the tamper track is on the top surface of the substrate 1001—i.e. on the same side of the substrate 1001 as the chip 1002 and antenna 1003—with only two short portions 1402 and 1403 of the tamper track extending to the underside of the substrate 1001. The short tamper track portions 1402 and 1403 are preferably applied to the underside of the substrate 1001 in a manner similar to the tamper track 1005 of FIG. 10. In some embodiments one or more layers of adhesion modifying coating may also be applied, as described herein, to enhance the destructibility of the tamper track portions 1402 and 1403. The tamper track portions 1402 and 1403 are connected to the portions of the tamper track 1401 on the top surface of the substrate 1001 by means of electrical through-connects 1404. The tamper track 1401 and antenna 1003 on the top surface of the substrate 1001 are electrically insulated from each other by regions of thin insulating material 1405 which in one embodiment are applied by means of a printing process. Another difference between the embodiment of FIG. 10 and the embodiment of FIG. 14 is that in the embodiment of FIG. 14 an adhesive layer is applied to the underside of the substrate 1001 only in the areas 1406 and 1407, which areas cover the tamper track portions 1401 and 1402 respectively, with no adhesive layer in other regions of the underside of the substrate 1001. The label of FIG. 14 is applied to a surface by applying the areas 1406 and 1407 of adhesive to the surface. The adhesive in areas 1406 and 1407 must be strong enough to ensure damage to the tamper track portions 1402 and 1403 when the label 1400 is tampered. In a variation on the embodiment of FIG. 14, another adhesive, which may be different from that applied in areas 1406 and 1407, may be applied to the rest of the underside of the substrate 1001.

In a specific embodiment of the design of FIG. 14, the antenna 1003 and portions 1401 of the tamper track on the top surface of the substrate 1001 may be made from a solid metal conductor such as Copper or Aluminum, while the tamper track portions 1402 and 1403 on the underside of the substrate 1001 may be made from a destructible electrically conducting ink. This configuration has the advantages of (i) strength and durability for the antenna and tamper track portions on the top surface of the substrate 1001, and (ii) lower overall production cost than an embodiment in which the antenna and all tamper track portions are made from a destructible electrically conducting ink.

The tamper indicating RFID label of FIG. 14 may be applied across the opening edge of a container, with the area 1406 of adhesive applied to the container on one side of the opening edge, and the area 1407 of adhesive applied to the container on the other side of the opening edge. In this implementation the design of FIG. 14 has the advantage that the label 1400 does not need to adhere to the contours of the container in any regions other than the contact regions for the adhesive areas 1406 and 1407.

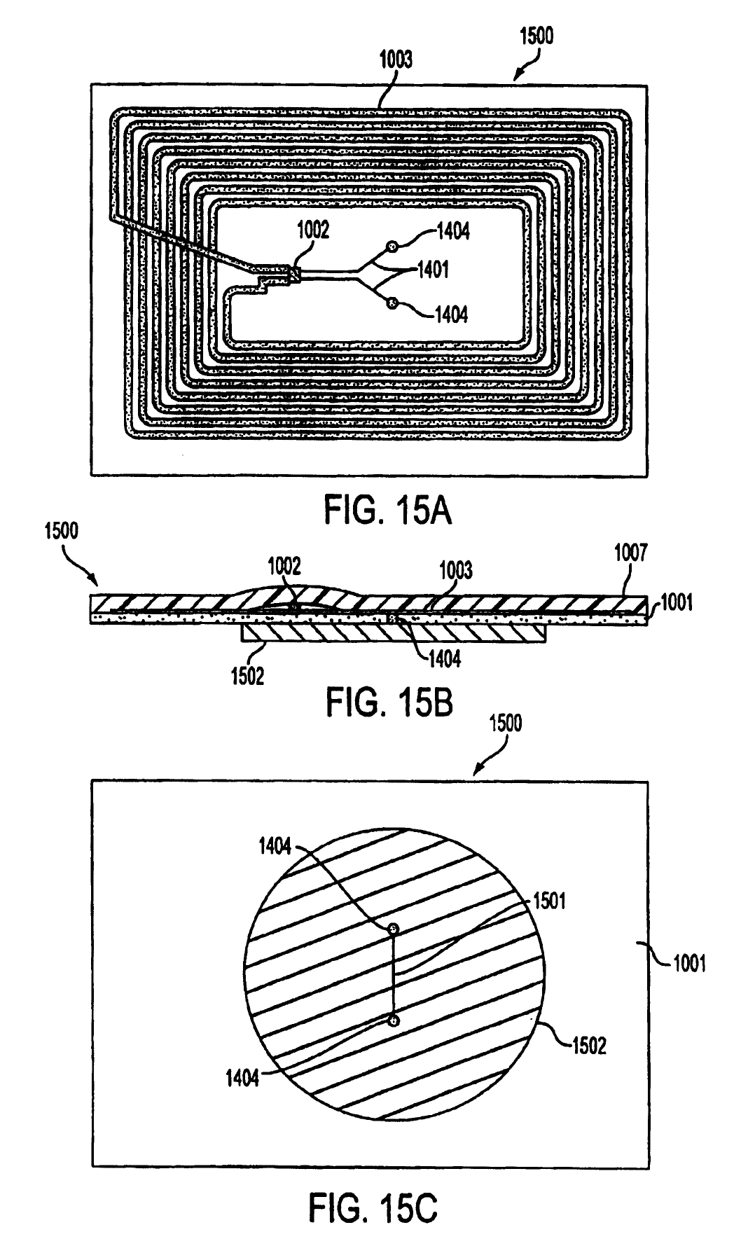

FIG. 15 shows a tamper indicating RFID label 1500, which is a variation on the embodiment of FIG. 14. FIG. 15 shows the label 1500 in top view (15A), cross-sectional side view (15B), and bottom view (15C). The difference between the embodiment of FIG. 14 and the embodiment of FIG. 15 is that in FIG. 15 there is only one tamper track portion 1501 on the underside of the substrate 1001 and consequently an adhesive layer is applied to the underside of the substrate 1001 only in the area 1502, which covers the tamper track portion 1501, with no adhesive layer in other regions of the underside of the substrate 1001. The label of FIG. 15 is applied to a surface by applying the adhesive area 1502 to said surface. The adhesive in area 1502 must be strong enough to ensure damage to the tamper track portion 1501 when the label 1500 is tampered. In a variation on the embodiment of FIG. 15, another adhesive, which may be different from that applied in area 1502, may be applied to the rest of the underside of the substrate 1001.

It should be appreciated that variations on the embodiments of FIGS. 14 and 15 are possible. FIG. 15 includes one tamper track portion on the underside of the substrate 1001, while FIG. 14 includes two tamper track portions on the underside of the substrate 1001. It should be appreciated that other embodiments, incorporating more than two tamper track portions on the underside of the substrate 1001, while embodying the other key features of the designs of FIGS. 14 and 15, are also possible. In the case of a design incorporating more than two tamper track portions on the underside of the substrate 1001, the tamper track portions may be arranged in a configuration which is suited to the configuration of a surface to which the tamper indicating RFID label is to be applied.

Incorporating a Tamper Indicating RFID Label with an Object

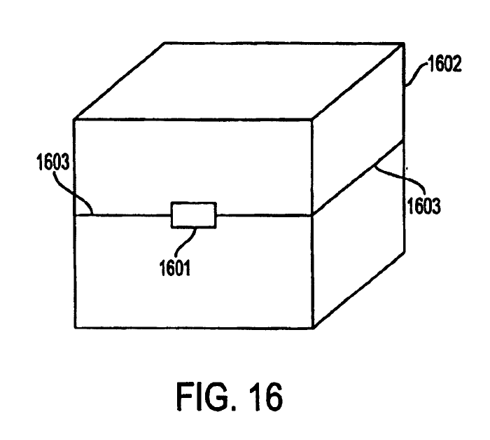

In another embodiment of the invention, a tamper indicating label is incorporated with an object to which the label is to be applied. The label used may be any of the embodiments described above. FIG. 16 illustrates a label 1601 applied to an object 1602. A conductive path 1603 should be incorporated into the object. For example, a conducting path of electrically conducting ink may be formed around the object. The conducting path 1603 on the object 1602 should have at least two end points. The tamper tracks in the label 1601 should have a corresponding number of connection points. When the label 1601 is applied to the object 1602, each end point should be connected to a connection point. The conducting path on the object 1602 and the tamper tracks in the label 1601 should together form one or more circuits, each from a tamper track to an endpoint, through the conducting path on the object, to the other end point and back to a tamper track. If a tamper track is disrupted through the label 1601 being tampered, or if connection between a tamper track and the conducting path on the object 1602 is broken, the RFID function of the label 1601 may be modified in a manner as described above, thereby indicating tampering. For example, if the label 1601 is applied to a cardboard box and the entire label and that part of the box the label is adhering to is cut out, tampering is indicated.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described.

I claim:

1. A tamper indicating label comprising:
an RFID layer providing an RFID function;
an adhesive layer supporting the RFID layer;
a destructible electrically conducting path between the RFID layer and the adhesive layer, whereby the destructible conducting path is disrupted when the label is tampered, thereby modifying the RFID function of the RFID layer.

2. The tamper indicating label of claim 1 wherein the destructible conducting path is formed from a sequence of regions of metal conductor and regions of electrically conducting ink.

3. The tamper indicating label of claim 1 wherein the destructible conducting path is formed from a thin metal conductor overlaid with a layer of electrically conducting ink.

4. The tamper indicating label of claim 1 wherein the destructible conducting path is an RFID component.

5. The tamper indicating label of any of claims 1-4 wherein the destructible conducting path is connected to RFID components in the RFID layer.

6. The tamper indicating label of any of claims 1-4 further comprising a pattern of an adhesion modifying coating between the RFID layer and the adhesive layer, the adhesion modifying coating modifying adhesion characteristics of the destructible conducting path.

7. The tamper indicating label of claim 6 wherein the pattern of the adhesion modifying coating includes at least two types of adhesion modifying coating.

8. The tamper indicating label of claim 6 wherein the adhesion modifying coating is printed on a bottom surface of the RFID layer and the destructible conducting path is formed on the adhesion modifying coating.

9. The tamper indicating label of claim 6 further comprising a visual tamper indicator arranged under the RFID layer and wherein the RFID layer is substantially transparent whereby the visual tamper indicator is visible.

10. The tamper indicating label of claim 9 wherein the visual tamper indicator is a colored layer and an adhesion-modifying substance is arranged between the RFID layer and the adhesive layer, the adhesion-modifying substance causing the colored layer to have different adhesion strengths with respect to the RFID layer and adhesive layer and thereby create a visual pattern on tampering of the label.

11. The tamper indicating label of any of claims 14 wherein the RFID layer includes a memory chip and one of an antenna and an induction loop.

12. A tamper indicating label comprising:
a substrate having first and second portions, the second portion being adapted to be looped back and connected to the first portion;
RFID components arranged on the substrate;
a tamper track arranged on the same side of the substrate as the RFID components, the tamper track being coupled to the RFID components and extending at least partially into the second portion of the substrate, the tamper track being exposed in a part of the second portion of the substrate;
an adhesive layer arranged over the exposed part of the tamper track, the tamper track being adapted to be modified when the label is tampered due to the relative adhesion strength of the tamper track to the adhesive layer, thereby modifying the RFID function of the RFID components.

13. The label of claim 12 wherein the second portion is connected to the first portion in an area where either the RFID components or the tamper track is arranged.

14. The label of any of claims 12 and 13 wherein a second adhesive layer is arranged on the first portion of the substrate in an area where the second portion is to be connected.

15. The label of any of claims 12 to 13 further comprising a top or bottom layer formed on regions of the substrate where the adhesive layer is not present.

16. The label of any of claims 12 to 13 wherein the RFID components include an integrated circuit chip and one of and induction and an antenna.

17. The label of claim 16 wherein the antenna or induction loop is arranged in the first portion of the substrate and the tamper track extends from the first portion of the substrate over the induction loop or antenna and into the second portion of the substrate.

18. The label of claim 17 further comprising an electrically insulating region arranged between the antenna or induction loop and the tamper track.

19. The label of any of claims 12 to 13 wherein the RFID components and the tamper track are formed on a top surface of the substrate.

20. The label of any of claims 12 to 13 wherein the adhesive layer contacts the tamper tracks.

21. A tamper indicating label comprising:
a substrate having first and second surfaces;
RFID components arranged on the first surface of the substrate;
at least one pair of through-connects extending through the substrate;
first tamper tracks formed on the first surface of the substrate and second tamper tracks formed on the second surface of the substrate, the second tamper tracks being connected between the through-connects to the first tamper tracks, whereby the first and second tamper tracks are electrically connected to each other; and
an adhesive layer arranged over the tamper tracks on the second surface of the substrate, whereby the second tamper tracks are interrupted or substantially disrupted when the label is at least partially removed from a surface to which it has been applied by means of the adhesive layer, thereby modifying RFID characteristics of the RFID components.

22. The label of claim 21, wherein the second tamper tracks are destructible.

23. The label of claim 21, wherein the first tamper tracks are formed from a metal and the second tamper tracks are formed from an electrically conductive ink.

24. The label of any of claims 21-23, wherein the RFID components include an integrated circuit chip and one of and induction and an antenna.

25. The label of any of claims 21-23, wherein the adhesive layer is only formed in an area around the second tamper tracks.

26. The label of claim 25, further comprising a second adhesive formed on the second surface of the substrate in areas where the adhesive layer is not formed.

27. The label of claim 21, where the first and second tamper tracks form one or more electrical circuits connected to the RFID components.

28. A method for reading information from an RFID label, the RFID label incorporating RFID apparatus that includes an integrated circuit chip, the method comprising:
storing a property of the RFID apparatus as first data values in a first memory of the integrated circuit chip;
reading the first data values from the first memory with an RFID read/write apparatus;
determining from the first data values if the RFID label has been tampered; and
writing second data values to a second memory of the integrated circuit with the RFID read/write apparatus if the RFID label has been tampered.

29. The method of claim 28, wherein the second data values are permanently recorded in the integrated circuit chip.

30. The method of claim 28, wherein the determining step comprises determining if the first data values fall within a predetermined range.
